(19) United States
(12) Patent Application Publication
(10) Pub. No.: US 2020/0097991 A1
(43) Pub. Date: Mar. 26, 2020

(54) SYSTEM AND METHOD FOR CONSUMER REWARDS REDEMPTION

(71) Applicant: GAMBIT DIGITAL PROMOTIONS INC., Westmount (CA)

(72) Inventors: Richard Pistilli, Westmount, CA (US); Peter Williams, New York, NY (US); Alex Matjanec, Brooklyn, NY (US)

(21) Appl. No.: 16/580,414

(22) Filed: Sep. 24, 2019

Related U.S. Application Data
(60) Provisional application No. 62/735,421, filed on Sep. 24, 2018.

(51) Int. Cl. G06Q 30/02; G06Q 50/34; G06Q 20/06

(52) U.S. Cl. CPC G06Q 30/0222; G06Q 20/065; G06Q 50/34

(57) ABSTRACT

There is provided a system and method for consumer rewards redemption. One or more virtual tokens are issued as a reward to a consumer. A number of the one or more virtual tokens issued to the consumer and a cash store of value associated with each of the one or more virtual tokens are recorded. At least one transaction is then performed using the one or more virtual tokens as digital currency.

### TECHNICAL FIELD

The present application claims priority under 35 U.S.C. 119(e) of Provisional Patent Application bearing Ser. No. 62,735,421 filed on Sep. 24, 2018, the entire contents of which are hereby incorporated by reference.

### TECHNICAL FIELD

The present disclosure relates to the field of consumer rewards, and more particularly to redemption of consumer rewards.

### BACKGROUND OF THE ART

Rewards programs (also referred to as ‘loyalty programs’) are used to encourage repeat business with given merchants. Such programs are typically provided in the form of rewards (e.g., discounts, coupons, points, retail gift cards, and the like), which are offered to consumers to create loyalty. Rewards programs are however restrictive due to complex regulations and rules on how to convert consumer rewards. For example, there often exists blackout periods during which rewards cannot be redeemed. Minimum purchase amounts may also be required to redeem the rewards. Furthermore, rewards programs that rely on intangible non-cash currencies, such as reward points, provide consumers with less incentive than programs that provide discounts on future purchases or programs that provide cash back rewards. As a result, consumers are awash with rewards that they cannot use and a large portion of consumer rewards thus remain unredeemed.

There is therefore a need for an improved system and method for consumer rewards redemption.

### SUMMARY

In accordance with a first broad aspect, there is provided a computer-implemented method for consumer rewards redemption. The method comprises issuing, at a computing device, one or more virtual tokens as a reward to a consumer, recording, at the computing device, a number of the one or more virtual tokens issued to the consumer and a cash store of value associated with each of the one or more virtual tokens, and performing, at the computing device, at least one transaction using the one or more virtual tokens as digital currency.

In some embodiments, issuing the one or more virtual tokens comprises receiving, at the computing device, a request to redeem one or more consumer rewards awarded to the consumer, and exchanging, at the computing device, the one or more consumer rewards for the one or more virtual tokens.

In some embodiments, the method further comprises, prior to exchanging the one or more consumer rewards for the one or more virtual tokens, validating that a balance of consumer rewards available in an account of the consumer matches an amount of the one or more consumer rewards, the account associated with a rewards program the consumer is participant in.

In some embodiments, the one or more consumer rewards are exchanged for the one or more virtual tokens using a one-to-one ratio where one virtual token is credited to the account of the consumer for each of the one or more consumer rewards.

In some embodiments, the one or more virtual tokens are issued to the consumer as a result of at least one financial operation performed by the consumer using a dedicated financial card.

In some embodiments, one virtual token is issued for each dollar amount spent by the consumer using the dedicated financial card.

In some embodiments, performing the at least one transaction comprises placing, through a gaming platform, at least one wager using the one or more virtual tokens as digital currency.

In some embodiments, the at least one wager is placed online.

In some embodiments, the method further comprises receiving the at least one wager, replicating the at least one wager with at least one gaming partner, and settling the at least one wager according to an outcome thereof.

In some embodiments, winning wagers are settled with cash and losing wagers are settled with at least one newly issued virtual token.

In accordance with a second broad aspect, there is provided a system for consumer rewards redemption. The system comprises a processing unit and a non-transitory computer-readable memory communicatively coupled to the processing unit and having stored thereon computer-readable program instructions executable by the processing unit for issuing one or more virtual tokens as a reward to a consumer, recording a number of the one or more virtual tokens issued to the consumer and a cash store of value associated with each of the one or more virtual tokens, and performing at least one transaction using the one or more virtual tokens as digital currency.

In some embodiments, the computer-readable program instructions are executable by the processing unit for issuing the one or more virtual tokens comprising receiving, at the computing device, a request to redeem one or more consumer rewards awarded to the consumer, and exchanging, at the computing device, the one or more consumer rewards for the one or more virtual tokens.

In some embodiments, the computer-readable program instructions are further executable by the processing unit for, prior to exchanging the one or more consumer rewards for the one or more virtual tokens, validating that a balance of consumer rewards available in an account of the consumer matches an amount of the one or more consumer rewards, the account associated with a rewards program the consumer is participant in.

In some embodiments, the computer-readable program instructions are executable by the processing unit for exchanging the one or more consumer rewards for the one or more virtual tokens using a one-to-one ratio where one virtual token is credited to the account of the consumer for each of the one or more consumer rewards.

In some embodiments, the computer-readable program instructions are executable by the processing unit for issuing the one or more virtual tokens to the consumer as a result of at least one financial operation performed by the consumer using a dedicated financial card.

In some embodiments, the computer-readable program instructions are executable by the processing unit for issuing one virtual token for each dollar amount spent by the consumer using the dedicated financial card.

In some embodiments, the computer-readable program instructions are executable by the processing unit for performing the at least one transaction comprising placing, through a gaming platform, at least one wager using the one or more virtual tokens as digital currency.

In some embodiments, the computer-readable program instructions are executable by the processing unit for placing the at least one wager online.

In some embodiments, the computer-readable program instructions are further executable by the processing unit for receiving the at least one wager, replicating the at least one wager with at least one gaming partner, and settling the at least one wager according to an outcome thereof.

In accordance with a third broad aspect, there is provided a non-transitory computer readable medium having stored thereon program code executable by at least one processor for issuing one or more virtual tokens as a reward to a consumer, recording a number of the one or more virtual tokens issued to the consumer and a cash store of value associated with each of the one or more virtual tokens, and performing at least one transaction using the one or more virtual tokens as digital currency.

### BRIEF DESCRIPTION OF THE DRAWINGS

Further features and advantages of the present invention will become apparent from the following detailed description, taken in combination with the appended drawings, in which:

FIG. 1A is a flowchart of a method for consumer rewards redemption, in accordance with an illustrative embodiment of the present invention;

FIG. 1B is a flowchart of the step of FIG. 1A of issuing virtual token(s) as a reward to a consumer, in accordance with a first embodiment;

FIG. 1C is a flowchart of the step of FIG. 1A of issuing virtual token(s) as a reward to a consumer, in accordance with a second embodiment;

FIG. 2 is a flowchart of the step of FIG. 1C of performing consumer rewards to virtual tokens conversion;

FIG. 3 is a flowchart of the step of FIG. 1A of using virtual token(s) in one or more speculative transactions;

FIG. 4 is a schematic diagram of a system for consumer rewards redemption, in accordance with an illustrative embodiment of the present invention; and

FIG. 5 is a schematic diagram of an application running on the processor of FIG. 4.

It will be noted that throughout the appended drawings, like features are identified by like reference numerals.

### DETAILED DESCRIPTION

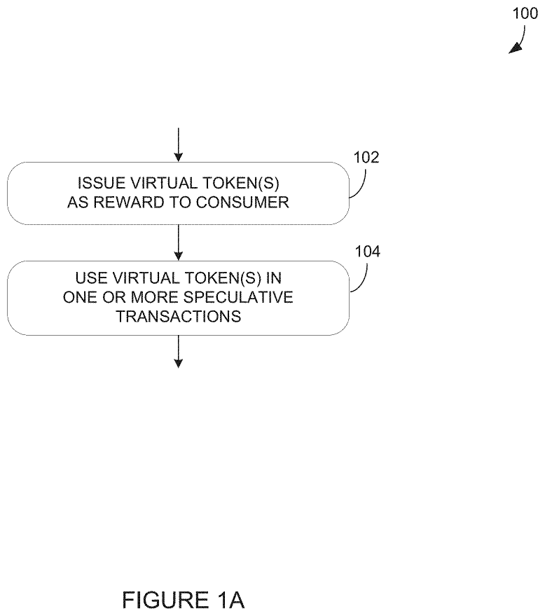

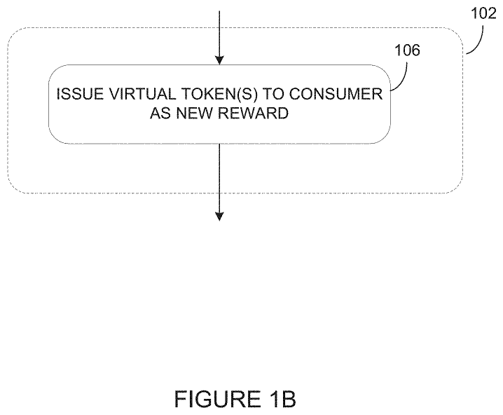

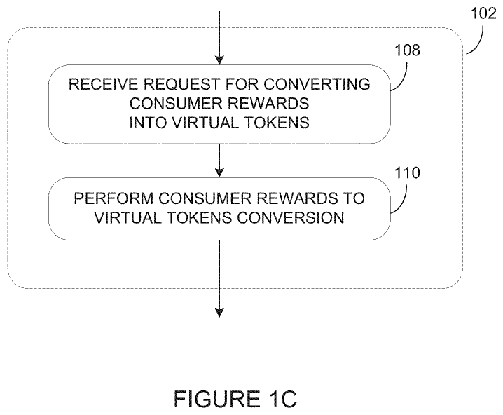

Referring to FIG. 1A, a method 100 for consumer rewards redemption, in accordance with one embodiment, will now be described. As will be discussed herein below, the method 100 is performed using a double-entry virtual account ledger. The ledger is used to extract and store a cash source pledged behind a consumer reward or rebate (e.g. reward points backed by sales commissions) in order to underwrite a digital asset separate (from the cash source) that can be used as a universal digital currency for subsequent speculative transactions, such as gaming or any other suitable activity. The virtual account ledger and associated method 100 may be implemented using a suitable digital or computing platform (referred to herein as a ‘virtual account ledger platform’).

In particular, the virtual account ledger keeps track of two simultaneous processes in real-time. In a first process, a consumer (also referred to herein as a user) is awarded a digital asset (referred to herein as a ‘virtual token’) as a new reward, or in exchange for his/her existing reward(s) or rebate(s). A corresponding entry is made in the virtual account ledger. Indeed, the virtual account ledger tracks the first process in real-time by indicating the number of virtual tokens each consumer has been granted. It should however be understood that the consumer may not take custody of the cash underwriting a given virtual token until the virtual token is exchanged by the virtual account ledger. Thus, in one embodiment, virtual tokens have no inherent value for users but have a cash store of value for third parties, such as gaming platforms. As known to those skilled in the art, a store of value refers to the function of an asset that can be saved, retrieved, and exchanged at a later time, the asset being predictably useful when retrieved. In one embodiment, the cash store of value is underwritten and tracked by the virtual account ledger who records, in real-time, a second process, in which ownership of the monetary (i.e. cash) value associated with the virtual tokens is acquired.

In other words, the virtual account ledger captures the cash source backing a consumer reward and separates the cash source from a digital asset that the virtual account ledger then issues to the consumer. This in turn enables the consumer to direct the use of third party capital in speculative transaction(s) and indirectly benefit from successful outcomes without contributing any personal consideration. Such speculative transactions are thus referred to herein as ‘no user consideration’ or ‘risk-free’.

The method 100 illustratively comprises, at step 102, issuing one or more virtual tokens as a reward to a consumer. As will be discussed further below, the systems and methods described herein generally relate to an underlying transaction that generates a consumer reward, sales commission, or rebate (e.g. using reward points or a dedicated debit card) that is in turn provided to the user in the form of a virtual token. As shown in FIG. 1B, in one embodiment, step 102 comprises issuing the virtual token(s) to the consumer as a new reward (step 106). In this embodiment, the consumer earns reward(s) for each transaction (e.g., financial or purchase transaction) performed using a dedicated debit card (also referred to herein as a “dedicated financial card”) associated with a given financial institution (e.g., bank), financial card provider, or payment processor. In particular, the consumer executes the transaction using the virtual account ledger platform as an intermediary, which results in the virtual account ledger platform directly collecting a cash rebate associated with the transaction. The virtual account ledger platform then gives to the user the reward of a virtual token for each dollar amount spent using the debit card. For example, a consumer may use the dedicated debit card and the virtual account ledger platform receives 1.0% in bank interchange fees. Instead of issuing the consumer a cashback reward, the virtual account ledger platform issues a virtual token and retains control over the cash source.

In another embodiment illustrated in FIG. 1C, step 102 comprises receiving, in real-time, a request for converting consumer reward(s) to virtual token(s) (e.g. redeeming the consumer reward(s)) (step 108). In one embodiment, the consumer rewards are reward point(s) collected as a result of one or more online activities being performed by a user. The one or more online activities comprise any consumer marketing activity including, but not limited to, online shopping, online survey completion, and watching media (e.g. videos, advertisements, etc.) online. The user may also collect reward point(s) by allowing a third party rewards program to track his/her online activity (e.g. search activity) and/or collect corresponding data. Other embodiments may apply. The collected reward point(s) may then be deposited to an account (‘referred to herein as a rewards program account’) the user holds with the third party rewards programs the user is participant in. It should be understood that any suitable rewards program may apply. It should also be understood that sales commissions may also apply as sales commissions may also be packaged as rewards to consumers.

The request for conversion may be received at step 108 further to the user entering an amount (e.g. a monetary value) he/she wishes to have credited to a virtual account, which is associated with the user and used to finance one or more transactions (also referred to herein as “speculative transactions”) performed by the user, as will be discussed herein below. For example, the user may indicate that they wish a credit of $1,000 to their virtual account. The request may also comprise an identifier that uniquely identifies the user with the third party rewards program. The conversion of the consumer rewards (e.g., one or more of the user's unused reward points) into one or more virtual tokens is then performed at step 110 of FIG. 1C. This conversion allows to fund the user's virtual account, which has an initial balance of zero virtual tokens. Each virtual token can therefore be seen as a digital asset (or currency) on which the user has a claim and that can be used in (e.g. as funds for) one or more subsequent speculative transactions at step 104.

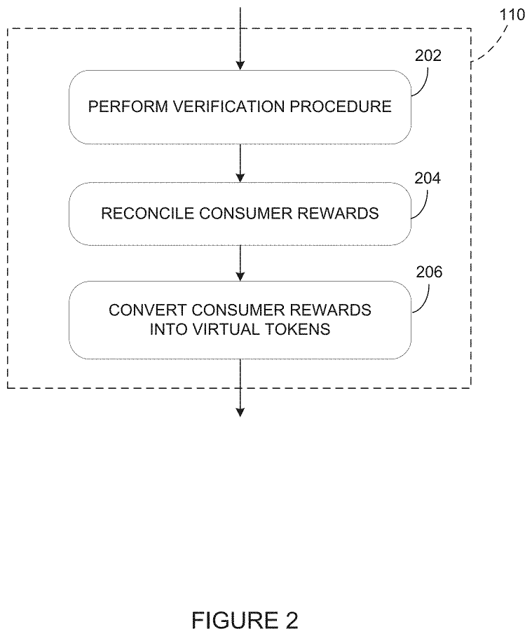

Referring now to FIG. 2, the step 110 of performing consumer rewards to virtual tokens conversion comprises performing a verification procedure at step 202. In one embodiment, the verification procedure comprises validating the identifier entered by the user as part of the request for rewards to tokens conversion. The identifier may be an email address that is associated with the user's rewards program account. The verification procedure may therefore entail sending a verification email (comprising a verification link) to the email address entered when the request was submitted. Upon the user selecting (e.g. clicking on) the verification link, a confirmation that the verification has been successfully completed is received. If the verification procedure fails, the method 100 may end.

Once the verification procedure has been successfully completed, the next step 204 is to reconcile the consumer rewards (e.g., the user's reward points). For this purpose, step 204 comprises validating that the user has a rewards program account and that the user's balance of reward points can (i.e. is sufficient to) cover or encompass the amount requested for conversion (e.g., the number of reward points available in the user's account is greater or equal to the amount requested for conversion). If the balance of reward points does not suffice (e.g., is lower than the amount requested) for conversion, the entire available balance may be withdrawn.

Once the user's identifier, account, and reward points balance have been validated, the transaction is approved and the consumer rewards (e.g., the one or more reward points) are converted into (e.g., exchanged into) virtual tokens at step 206. In one embodiment, the conversion procedure uses a one-to-one conversion ratio between the reward points and the virtual tokens, such that, for each reward point, one virtual token is credited to the user's virtual account. It should however be understood that other suitable conversion ratios may apply. Once the conversion has been performed, the balance of the user's virtual account is updated in real-time with the number of earned virtual token(s) and the user is notified (using any suitable communication means, such as email, text message, or the like) of the outcome (i.e. success or failure) of the transaction in real-time.

The one or more virtual tokens can then be used in (e.g. as funds for) one or more speculative transactions at step 104 of FIG. 1A. The one or more speculative transactions may be performed online. For example, in one embodiment, virtual tokens are used for online (e.g. Internet or mobile) gaming, such as to place wagers (e.g., no user consideration, risk-free speculative wagers) through one or more gaming platforms that provide a plurality of games. The games (also referred to as ‘matches’ or ‘contests’) may be single games (between two players or teams, e.g. sport teams) or free-form games (between more than two players or teams). In other words, the one or more virtual tokens provide the users with free entry (or access) to the one or more contests. The games may be any suitable games including, but not limited to, sports, casino, poker, horse racing, slots, bingo, scratch card games. In one embodiment, the one or more virtual tokens are illustratively non-transferable and may only be used for the above-mentioned transactions (e.g. do not provide any value outside the gaming platform(s) and may not be sold or otherwise transferred). It should be understood that the gaming platform(s) may be provided separately from the virtual account ledger platform or integrated therewith. It should also be understood that the one or more speculative transactions need not be performed online but are instead performed in the real (i.e. physical) world. For example, at step 104, the user may use the virtual tokens to purchase chips in a casino. Other embodiments may apply.

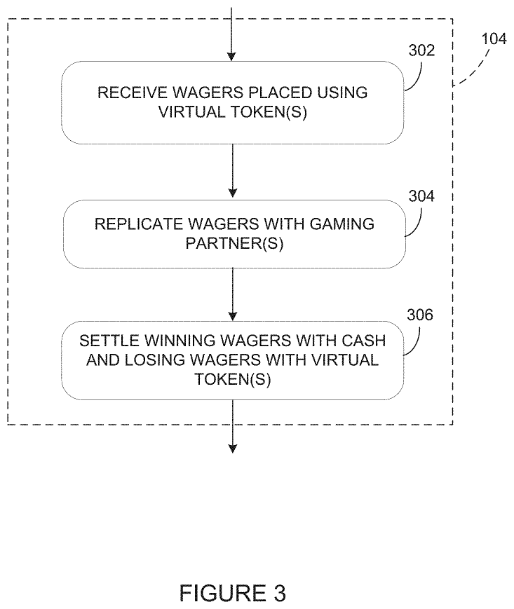

As illustrated in FIG. 3, step 104 of FIG. 1A may comprise receiving one or more gaming wagers placed using the virtual token(s) (step 302). Each received wager may be stored in memory in any suitable format. In one embodiment, each wager is stored as an entry including, but not limited to, a wager identifier, a game identifier, a wager (i.e. virtual token) amount, a date and time the wager is placed, odds, payout, and a current status (e.g., confirmed, declined, won, lost, refunded) of the wager. The received wagers are then confirmed (i.e. approved or denied based on user authentication or other relevant criteria) and at step 304 the wagers are replicated with (e.g. exported to) one or more gaming partners associated with the gaming platform(s) (or with the virtual account ledger platform).

At step 306, wagers are settled in accordance with an outcome (i.e. winning or losing) thereof, as determined at the gaming platform(s). Winning wagers are settled with cash (referred to herein as a ‘withdrawal’ or ‘cash-out’) and losing wagers are settled with virtual token(s). In one embodiment, once a wager is marked as won, a conversion rate of one virtual token to a monetary value of $0.01 is used. It should however be understood that other conversion rates may apply. It should also be understood that a withdrawal is illustratively only performed on cash that comes from winnings generated from the gaming activity mentioned above. In one embodiment, each virtual token is also associated with a number of game play iterations (predetermined or selected by the user) such that, once the number of iterations has been reached, the user cannot continue placing wagers and the user proceeds with the withdrawal.

In one embodiment, the cash withdrawal process comprises receiving from the user a request for a conversion of virtual tokens and a withdrawal of cash from the user's virtual account to a financial account held by the user at a given financial institution or online payment service provider, such as PayPal. The request indicates the amount to be withdrawn and identifies the financial institution or payment service provider. Upon receiving the request, a verification email comprising a verification link is sent to the email address associated with the user's virtual account. Upon receiving a confirmation that the verification has been successfully completed (e.g. responsive to the user clicking on the verification link), the withdrawal request may be submitted to an application programming interface (API) associated with the financial institution or payment service provider. Upon submission to the API, the requested cash amount is in turn deducted from the user's virtual account and transferred to the user's financial account. The user is then notified accordingly in real-time.

As discussed above, it should be understood that, from the perspective of the gaming platform(s), virtual tokens represent a digital currency with a cash store of value as underwritten and tracked by the virtual account ledger. However, from the users' perspective, the virtual tokens have no inherent or underlying value. The virtual account ledger is therefore used to facilitate any third party cash settlement (e.g. settlements with third party gaming partners with which the wagers were replicated). Such cash settlement is not property of the user and does not pass through their custody. In other words, any third party cash settlement is reconciled by the virtual account ledger rather than by the user.

It should also be understood that, in one embodiment, the user may also elect to rescind some or all of their virtual tokens and have the associated cash value backed by the virtual account ledger donated to a charitable cause. In that instance, the cash underlying the virtual tokens is transferred from the ownership of the virtual account ledger platform to the charity, without the user possessing ownership of the funds.

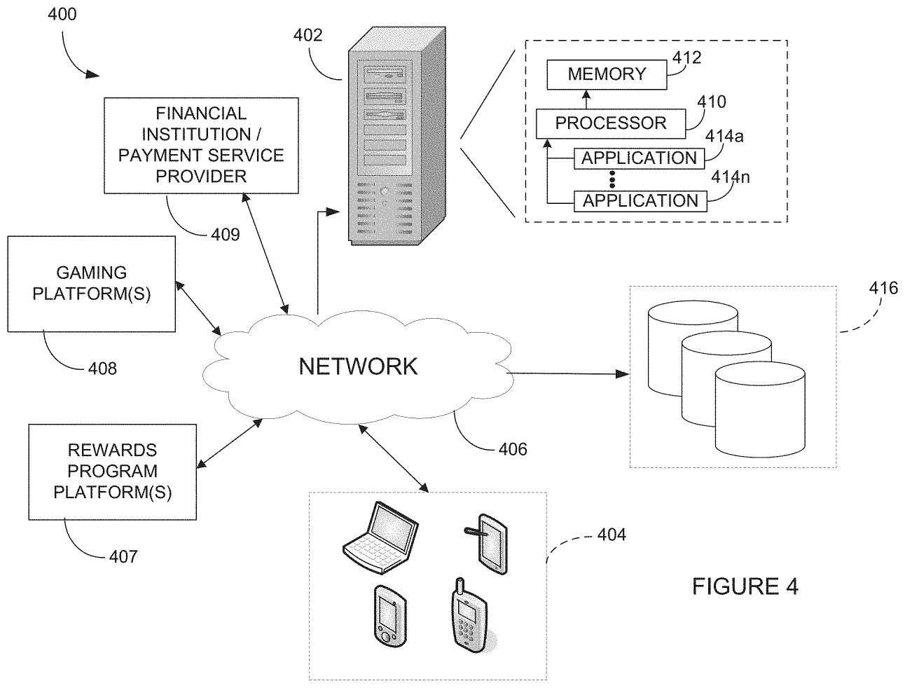

Referring now to FIG. 4, a system 400 for consumer rewards redemption, in accordance with one embodiment, will now be described. The system 400 illustratively implements the virtual account ledger described herein above. The system 400 may comprise one or more server(s) 402 adapted to communicate with a plurality of mobile devices 404 via a network 406, such as the Internet, a cellular network, Wi-Fi, or others known to those skilled in the art. As will be discussed further below, the devices 404 may provide users access to the system 400, as well as to one or more rewards programs platforms 407, one or more gaming platforms 408, and a financial institution or payment service provider 409. The devices 404 may comprise any device, such as a laptop computer, a personal digital assistant (PDA), a tablet, a smartphone, or the like, adapted to communicate over the network 406. It should be understood that the gaming platform(s) 408 may be provided separately from the virtual account ledger platform or integrated therewith.

In one embodiment, the system 400 requires users to log in or otherwise gain authorized access to the system 400 through the use of a unique identifier. For this purpose, users illustratively register with the system 400 by completing an application, thereby creating a unique profile that may be stored in the memory 412 and/or databases 416. This may be done by accessing, using the user's device 404, a website associated with the system 400. Once registration is complete, each user may be provided with a unique identifier, such as an email address, a username, and/or a password. The unique identifier may be encrypted using any encryption method and is associated with the user's profile. The identifier may be used to verify the identity of the user upon the user attempting to access the system 400.

Access to the system 400 may then be effected by the user logging on to the website associated with the system 400, using the identifier. Alternatively, the system 400 may be installed on the device 404 as a software application, which may be launched by the user on the device 404. It should be understood that the system 400 may be accessed by multiple users simultaneously. It should also be understood that a given user may log into the system 400 using an identifier associated with an online social network or social networking application (e.g. Facebook™, Google+™, Twitter™ or the like) to which the user has subscribed.

The server 402 may comprise a series of servers corresponding to a web server, an application server, and a database server. These servers are all represented by server 402 in FIG. 4. The server 402 may comprise, amongst other things, a processor 410 coupled to a memory 412 and having a plurality of applications 414a, . . . , 414n running thereon. The processor 410 may access the memory 412 to retrieve data. The processor 410 may be any device that can perform operations on data. Examples are a central processing unit (CPU), a microprocessor, and a front-end processor. The applications 414a, . . . , 414n are coupled to the processor 410 and configured to perform various tasks as explained below in more detail. It should be understood that while the applications 414a, . . . , 414n presented herein are illustrated and described as separate entities, they may be combined or separated in a variety of ways. It should be understood that an operating system (not shown) may be used as an intermediary between the processor 410 and the applications 414a, . . . , 414n.

The memory 412 accessible by the processor 410 may receive and store data. The memory 412 may be a main memory, such as a high speed Random Access Memory (RAM), or an auxiliary storage unit, such as a hard disk or flash memory. The memory 412 may be any other type of memory, such as a Read-Only Memory (ROM), Erasable Programmable Read-Only Memory (EPROM), or optical storage media such as a videodisc and a compact disc. Also, although the system 400 is described herein as comprising the processor 410 having the applications 414a, . . . , 414n running thereon, it should be understood that cloud computing may also be used. As such, the memory 412 may comprise cloud storage.

One or more databases 416 may be integrated directly into the memory 412 or may be provided separately therefrom and remotely from the server 402 (as illustrated). In the case of a remote access to the databases 416, access may occur via any type of network 406, as indicated above. The databases 416 described herein may be provided as collections of data or information organized for rapid search and retrieval by a computer. The databases 416 may be structured to facilitate storage, retrieval, modification, and deletion of data in conjunction with various data-processing operations. The databases 416 may consist of a file or sets of files that can be broken down into records, each of which consists of one or more fields. Database information may be retrieved through queries using keywords and sorting commands, in order to rapidly search, rearrange, group, and select the field. The databases 416 may be any organization of data on a data storage medium, such as one or more servers. As discussed above, the system 400 may use cloud computing and it should therefore be understood that the databases 416 may comprise cloud storage.

In one embodiment, the databases 416 are secure web servers and Hypertext Transport Protocol Secure (HTTPS) capable of supporting Transport Layer Security (TLS), which is a protocol used for access to the data. Communications to and from the secure web servers may be secured using Secure Sockets Layer (SSL). Identity verification of a user may be performed using usernames and passwords for all users. Various levels of access authorizations may be provided to multiple levels of users.

Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol).

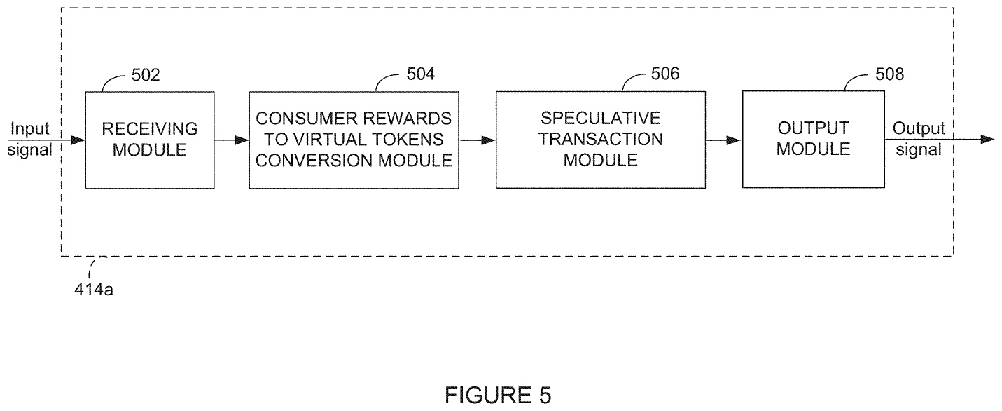

FIG. 5 is an exemplary embodiment of an application 414a running on the processor 410 of FIG. 4. The application 414a illustratively comprises a receiving module 502, a consumer rewards to virtual tokens conversion module 504, a speculative transaction module 506, and an output module 508.

The receiving module 502 illustratively receives one or more input signals from one or more device(s) 404. The input signal(s) received from each device 404 may comprise data uniquely identifying the user, e.g. the user's identifier associated with his/her account in the system 400. The user identifier may indeed be received upon the user attempting to gain access to the system 400. The input signal(s) received from a device 404 at the receiving module 502 may also comprise request data indicative of the user's request to convert his/her consumer rewards (e.g., unused rewards points) into virtual tokens, as discussed herein above.

The request data is then sent to the consumer rewards to virtual tokens conversion module 504, which is configured to perform the conversion in the manner discussed herein above with reference to FIG. 1C and FIG. 2. For this purpose, the consumer rewards to virtual tokens conversion module 504 may access the rewards program platform(s) 407, for instance to perform the verification and reconciliation procedures discussed above. The consumer rewards to virtual tokens conversion module 504 may be configured to generate and transmit the virtual tokens. The consumer rewards to virtual tokens conversion module 504 may indeed be in operative and/or electronic communication with the speculative transaction module 506 such that the virtual tokens are then sent thereto. The speculative transaction module 506 may be configured to use the virtual tokens in one or more transactions (also referred to herein as speculative transactions), such as gaming, as described above with reference to FIG. 3. For this purpose, the speculative transaction module 506 may access the gaming platform(s) 408 (e.g., to receive/replicate wagers placed using the virtual tokens and receive an outcome thereof) and the financial institution/payment service provider 409 (e.g., to settle wagers and perform cash withdrawals or donations from the user's virtual account to a financial account held by the user at the financial institution or the online payment service provider). The output module 508 is then used to output to the user one or more notifications (e.g., in the form of output signal(s)), such as notifying the user of the balance of their virtual account or of an outcome of a requested cash withdrawal or donation, as discussed herein above.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

It should be noted that the present invention can be carried out as a method, can be embodied in a system, and/or on a computer readable medium. The embodiments of the invention described above are intended to be exemplary only. The scope of the invention is therefore intended to be limited solely by the scope of the appended claims.

1. A computer-implemented method for consumer rewards redemption, the method comprising:
issuing, at a computing device, one or more virtual tokens as a reward to a consumer;
recording, at the computing device, a number of the one or more virtual tokens issued to the consumer and a cash store of value associated with each of the one or more virtual tokens; and
performing, at the computing device, at least one transaction using the one or more virtual tokens as digital currency.

2. The method of claim 1, wherein issuing the one or more virtual tokens comprises:
receiving, at the computing device, a request to redeem one or more consumer rewards awarded to the consumer; and
exchanging, at the computing device, the one or more consumer rewards for the one or more virtual tokens.

3. The method of claim 2, further comprising, prior to exchanging the one or more consumer rewards for the one or more virtual tokens, validating that a balance of consumer rewards available in an account of the consumer matches an amount of the one or more consumer rewards, the account associated with a rewards program the consumer is participant in.

4. The method of claim 3, wherein the one or more consumer rewards are exchanged for the one or more virtual tokens using a one-to-one ratio where one virtual token is credited to the account of the consumer for each of the one or more consumer rewards.

5. The method of claim 1, wherein the one or more virtual tokens are issued to the consumer as a result of at least one financial operation performed by the consumer using a dedicated financial card.

6. The method of claim 5, wherein one virtual token is issued for each dollar amount spent by the consumer using the dedicated financial card.

7. The method of claim 1, wherein performing the at least one transaction comprises placing, through a gaming platform, at least one wager using the one or more virtual tokens as digital currency.

8. The method of claim 7, wherein the at least one wager is placed online.

9. The method of claim 7, further comprising receiving the at least one wager, replicating the at least one wager with at least one gaming partner, and settling the at least one wager according to an outcome thereof.

10. The method of claim 9, wherein winning wagers are settled with cash and losing wagers are settled with at least one newly issued virtual token.

11. A system for consumer rewards redemption, the system comprising:
a processing unit; and;
a non-transitory computer-readable memory communicatively coupled to the processing unit and having stored thereon computer-readable program instructions executable by the processing unit for:
issuing one or more virtual tokens as a reward to a consumer;
recording a number of the one or more virtual tokens issued to the consumer and a cash store of value associated with each of the one or more virtual tokens; and
performing at least one transaction using the one or more virtual tokens as digital currency.

12. The system of claim 11, wherein the computer-readable program instructions are executable by the processing unit for issuing the one or more virtual tokens comprising:
receiving, at the computing device, a request to redeem one or more consumer rewards awarded to the consumer; and
exchanging, at the computing device, the one or more consumer rewards for the one or more virtual tokens.

13. The system of claim 12, the computer-readable program instructions are further executable by the processing unit for, prior to exchanging the one or more consumer rewards for the one or more virtual tokens, validating that a balance of consumer rewards available in an account of the consumer matches an amount of the one or more consumer rewards, the account associated with a rewards program the consumer is participant in.

14. The system of claim 13, wherein the computer-readable program instructions are executable by the processing unit for exchanging the one or more consumer rewards for the one or more virtual tokens using a one-to-one ratio where one virtual token is credited to the account of the consumer for each of the one or more consumer rewards.

15. The system of claim 11, wherein the computer-readable program instructions are executable by the processing unit for issuing the one or more virtual tokens to the consumer as a result of at least one financial operation performed by the consumer using a dedicated financial card.

16. The system of claim 15, wherein the computer-readable program instructions are executable by the processing unit for issuing one virtual token for each dollar amount spent by the consumer using the dedicated financial card.

17. The system of claim 11, wherein the computer-readable program instructions are executable by the processing unit for performing the at least one transaction comprising placing, through a gaming platform, at least one wager using the one or more virtual tokens as digital currency.

18. The system of claim 17, wherein the computer-readable program instructions are executable by the processing unit for placing the at least one wager online.

19. The system of claim 17, the computer-readable program instructions are further executable by the processing unit for receiving the at least one wager, replicating the at least one wager with at least one gaming partner, and settling the at least one wager according to an outcome thereof.

20. A non-transitory computer readable medium having stored thereon program code executable by at least one processor for:
issuing one or more virtual tokens as a reward to a consumer;
recording a number of the one or more virtual tokens issued to the consumer and a cash store of value associate with each of the one or more virtual tokens; and
performing at least one transaction using the one or more virtual tokens as digital currency.
